(19) United States
(12) Patent Application Publication
(10) Pub. No.: US 2004/0101705 A1
(43) Pub. Date: May 27, 2004

(54) Adhesive for wood, woody material

(75) Inventors: Eisaku Tozaka, Kyoto (JP); Koichi Nishimoto, Kyoto (JP); Tamotsu Okada, Kyoto (JP)

Correspondence Address: BANNER & WITCOFF, 1001 G STREET N W, SUITE 1100, WASHINGTON, DC, 20001, US

(73) Assignees: Koichi NISHIMOTO, Kyoto (JP); TOPIX Co., Ltd., Kyoto (JP)

(21) Appl. No.: 10/697,104

(22) Filed: Oct. 31, 2003

(30) Foreign Application Priority Data
Nov. 5, 2002 (JP) P2002-321544

(51) Int. Cl. C08K 3/00

(52) U.S. Cl. 428/535; 428/537.1; 523/118

(57) ABSTRACT

A high-security, low-cost, corrosion proof, insect proof such as ant proof, low in formic aldehyde concentration level and significantly useful adhesive for wood is provided and a woody material such as plywood manufactured by the use of the adhesive is also provided.

Cedarwood oil 4 is mixed into a resin base 3 as a main component of the adhesive 2 so as to constitute the adhesive 2 for wood and the adhesive 2 is used to bond single panels 10 constituting the woody material such as plywood 1.

### BACKGROUND OF THE INVENTION AND RELATED ART STATEMENT

This invention relates to an adhesive for wood that is safe and has a corrosion proof and ant-proof effect and a woody material using the adhesive.

Plywood is a highly useful and versatile woody material that can be use in varieties of field such as building materials, civil engineering, display decorations, furniture, fixtures, household electronic appliances, ships and vessels, vehicles, aircraft, musical instruments, sporting equipment, transport and packing materials, office supplies and bags. Various types of specification commencing with JAS (Japanese Agricultural Standards) are set as usage. Generally the plywood has an arrangement of an odd-number of woody single panels are overlapped in layers and each of the single panels are bonded with an adhesive. The adhesive is standardized into a special group (phenol resin adhesive), 1 group (melamine resin adhesive) <type 1>, 2 group (urea resin adhesive) <type 2> and 3 group (added urea resin adhesive, casein glue). Recently formic aldehyde included in the adhesive is considered to be a cause of sick house syndrome and especially a threshold limit value of formic aldehyde is established by the JAS. Then low formic aldehyde plywood has been prevailing especially for a housing or furniture use. (For example, refer to non-patent document 1) In order to prevent the plywood from being decayed due to wood corrosion fungus such as Perenniporia fraxinea or Coriolus versicolor that has been attached to the single panel sawn from a raw wood or to prevent the plywood from an insect damage of termites or Lyctus brunneus decay treated plywood/ant-proof treated plywood or decay and ant-proof treated plywood using an adhesive into which a preservative substance or insect repellent is mixed has been used. Some of the above plywood gets a certification of Approved Quality (so to speak, AQ mark) from Japan Housing and Wood Technology Center. (For example, refer to non-patent document 2)

For example, as medical agent certified with the above-mentioned AQ mark in a category of corrosion proof, termite proof treated plywood are at the present moment copper naphthenate (emulsifiable concentrate), alkyle ammonium compound system, copper/alkyle ammonium compound system, versatic acid zinc/pyrethroid system, copper/boric acid azole compound system, copper/azole compound system, zinc naphthenate (oil solution), propetanphos/azole compound system, boric acid/alkyle ammonium compound system, lignin/copper/boron compound system, lignin/copper/azole compound system, nicotyle/azole compound system and organosilicon/alkyle ammonium compound system. (For example, non-patent document 3)

The plywood has an arrangement that an odd number of single plates are overlapped in a condition that a fibrous direction of each adjacent single panel makes a right angle alternately. Recently appear laminated veneer lumber (so to speak, LVL) wherein a plurality of singles are overlapped in a condition that a fibrous direction of all single pan ls is the same and particleboard used as a column wherein a plurality of wortles are overlapped in a condition that a fibrous direction of all wortles is the same. The laminated veneer lumber and the particleboard also have an arrangement that each of single panels or each of wortles are bonded with the same adhesive as the adhesive for plywood and the same standard exists for the adhesive. Most of the available plywood, laminated veneer lumber and the particleboard are adjusted to the standard.

(non-patent document 1) “All about the PLY WOOD” (on line) 2001 version, Tokyo Plywood Manufacturers' Association, Touhoku Plywood Manufacturers' Association, p12˜p15.

(non-patent document 2) “Approved Quality (AQ mark”) (on line) Japan Housing and Wood Technology Center (searched in Oct. 1, 2002)

<URL : http://www.howtec.or.jp/ninsyou/aq/aq-about.html>

(non-patent document 3) “Target medicine and medicine absorbing amount by performance of AQ preservative treated products” (on line) Japan Housing and Wood Technology Center (searched in Oct. 1, 2002)

<URL : http://www.howtec.or.jp/ninsyou/aq/aq-yakuzai-kyuusyuu.html# Structural Plywood treated with preservative agent and termite proof agent>

All of the medical agents included in the above-mentioned adhesive are inorganic salt of synthetic organic compound or organic compound or mixture of them. They are at least confirmed safe, however, it is hard to say that an effect of the above medical agents after a long term use is clear. In addition, several different medical agents may have to be used in order to obtain both effects of corrosion proof and insect proof. Further, a manufacturing cost of the medical agents is high and some of the medical agents requires careful handling. There is also a need to replay to a recent demand of lowering a formic aldehyde concentration.

The present claimed invention intends to provide a high-security, low-cost, corrosion proof, insect proof such as termite proof, low in formic aldehyde concentration level and significantly useful adhesive for wood and a woody material such as plywood manufactured by the use of the adhesive.

### SUMMARY OF THE INVENTION

The adhesive for wood in accordance with the present claimed invention is characterized by that cedarwood oil is mixed into a resin base as a main component of the adhesive so as to constitute the adhesive for wood.

As the resin base used are a special group (phenol resin adhesive), 1 group (melamine resin adhesive) <type 1>, 2 group (urea resin adhesive) <type 2> and 3 group (added urea resin adhesive, casein glue) specified by JAS. In addition, resin used as an adhesive for wood can be applied. The cedarwood oil is extracted liquid of wood that is available at a relatively low-cost and that is represented by Aomori cedarwood, Taiwanese cypress, Kiso cypress or the like and contains a useful substance commencing with Hinokitiol (C₁₀H₁₂O₂) and beta-dolabrin (C₁₀H₁₀O₂) as an analogous body of Hinokitiol. The cedarwood oil containing Hinokitiol is known to demonstrate a highly rejecting behavior against harmful insects such as termite and a significantly high insect proof spectrum and anti-bacterial spectrum that produce a strong action to reduce fertility of fungus or molds. In addition, the cedarwood oil has been recognized of producing an eliminant against volatile organic compounds (VOC) such as formic aldehyde and curative properties against atopic dermatitis. As a result, in the present claimed invention the cedarwood oil is mixed into the resin base, which makes it possible for a woody material such as plywood using the adhesive for wood to produce a corrosion proof/termite proof effect. In addition, a discharging amount of formic aldehyde added to the adhesive can be reduced due to the eliminant behavior against VOC of the cedarwood oil.

The cedarwood oil mixed into the resin base can be a concentrate solution or a diluted solution. As a form of mixing the cedarwood oil into the resin represented are that the cedarwood oil in a form of liquid is added to the resin base or the cedarwood oil retained by a material other than the resin base is mixed into the resin base.

More concretely, it is preferable that a porous particle having a humidity adjusting behavior is mixed into the resin base and the cedarwood oil is retained by the porous particle. In accordance with the arrangement of the adhesive for wood, since the cedarwood oil is absorbed by fine apertures formed on the porous particle, the cedarwood oil evaporates from the adhesive for wood gradually. As a result, all of the cedarwood oil does not evaporate at once and the above-described effect can be obtained for a long term. A form of retaining the cedarwood oil by the porous particle is not limited to that the cedarwood oil is absorbed by the fine aperture. More specifically, the form of retaining the cedarwood oil may be that a micro capsule that comprises a hollow septal wall made of a plurality of porous particles and the cedarwood oil included in the septal wall and that can discharge the cedarwood oil out of the septal wall through a fine porosity of the porous particles constituting the septal wall or a part of a flaked septal wall is formed and the micro capsule is mixed into the resin base. The cedarwood oil evaporates gradually through a gap between the porous particles, fine apertures of the porous particle and a part of the flaked septal wall from the micro capsule having the above arrangement, thereby to produce the above-mentioned effect.

As the porous particles represented is either one of silica gel (SiO₂), diatomite, zeolite and pumicite or a mixture of more than two of silica gel, diatomite, zeolite and pumicite.

In case the resin base contains a mineral thickening agent, the cedarwood oil may be retained by the mineral thickening agent. In accordance with the arrangement, the above-mentioned effect can be fully obtained. As the mineral thickening agent represented is sepiolit.

In order to improve corrosion proof, antibacterial effect and durability of the adhesive, it is possible that liquid containing Hinokitiol or a metal complex Hinokitiol is mixed into the resin base instead of the cedarwood oil. As a metal forming the metal complex represented are Mg (magnesium), Al (aluminum), Ca (calcium), Na (natrium) and Cu (copper).

The woody material using the above-mentioned adhesive for wood in accordance with the present claimed invention is, more specifically, the woody material wherein a plurality of woody single panels or a plurality of wortles are overlapped in layers and each of adjacent single panels or each of adjacent wortles is bonded with an adhesive for wood applied between the adjacent single panels or the adjacent wortles and characterized by that a main component of the adhesive for wood is a resin base for an adhesive and cedarwood oil is mixed into the resin base. It is possible to obtain the woody material that can produce all of the effect of corrosion proof, insect proof and lowering a concentration of formic aldehyde due to the effect produced by the cedarwood oil blended in either one of the above-mentioned forms.

As a concrete form of the woody material represented are plywood wherein an odd number of the single panels are arranged in a condition that a fibrous direction of each adjacent single panel makes a right angle alternately, laminated veneer lumber wherein a plurality of the single panels are arranged in a condition that a fibrous direction of each adjacent single panel is generally parallel and particleboard wherein a plurality of the wortles are arranged in a condition that a fibrous direction of each adjacent wortle is generally parallel. For the above-mentioned woody material, liquid containing a metal complex Hinokitiol may be mixed into the resin base instead of the cedarwood oil.

### BRIEF DESCRIPTION OF THE DRAWINGS

FIG. 1 is an explanatory diagram showing a pattern of a manufacturing process of plywood in accordance with an embodiment of the present claimed invention.

FIG. 2 is a cross-sectional view showing a pattern of the plywood in accordance with the embodiment.

FIG. 3 is an explanatory diagram showing a magnified fifth process in FIG. 1.

FIG. 4 is a cross-sectional view showing a pattern of synthetic silica gel retaining cedarwood oil that is applied to an example of an adhesive for wood used for the plywood in accordance with the embodiment.

FIG. 5 is a cross-sectional view showing a pattern of a microcapsule retaining cedarwood oil that is applied to an example of an adhesive for wood used for the plywood in accordance with the embodiment.

### DETAILED DESCRIPTION OF THE PREFERRED EMBODIMENTS

An embodiment of the present claimed invention will be described in detail with reference to the accompanying drawings.

In this embodiment, a plywood making use of an adhesive for wood will be explained as an example of a woody material.

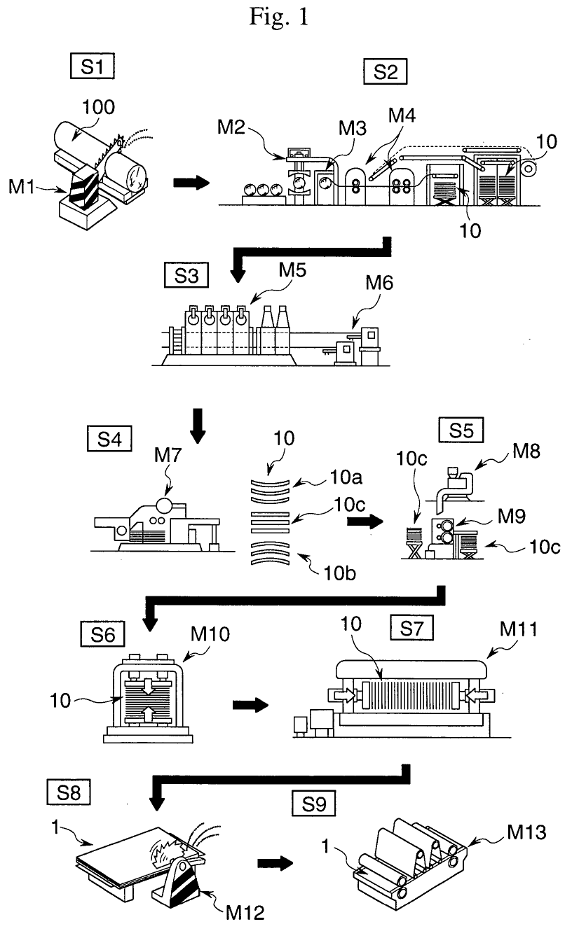

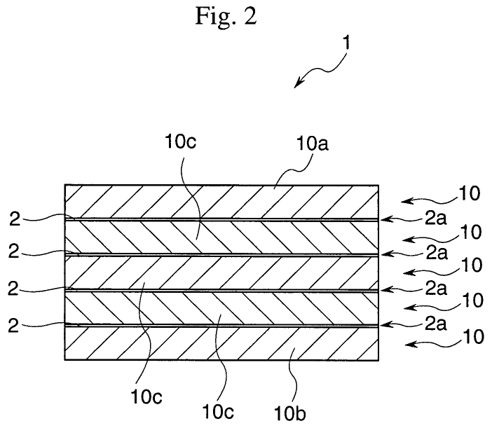

FIG. 1 generally shows a manufacturing process of plywood 1. First, a manufacturing process of the plywood 1 will be briefly explained with reference to FIG. 1. In a first process S1 raw wood 100 is cross cut. More specifically, the raw wood 100 that is a log after landed is cut in a predetermined length. A steaming process may be provided after cutting the log. As a kind of the raw wood 100 applied is either one of broad leaf trees such as linden, birch, satinwood, beech, oak, lauan or PNG and coniferous trees such as red pine, silver fir, cedars, larch, yellow pine, hemlock fir, spruce, southern pine or pine, each of which is prevailing as raw wood for plywood. In a second process S2 cutting of the raw wood 100 and heap of a single panel 10 are conducted. More specifically, the raw wood 100 cut in the first process S1 is spin finished by a centering device M2 called a charger. The raw wood 100 is peeled by a rotary lathe M3 and cut into the single panels 10 having a width of about 0.6˜5.0 mm. Next the cut raw wood 100 is clipped by a cutting machine (a clipper) M4. And the single panels 10 are classified into a face veneer 10a, a back veneer 10b or a center slate 10c and piled according to the classification. In a third step S3 the single panels 10 are dried and cut. More specifically, the single panels 10 are dried with vapor or heat of 160 degr es centigrade ˜200 degrees centigrade from a boiler by a single panel dryer (a dryer) M5 and then cut into a predetermined size by a cutting machine M6. In a forth step S4 the single panels 10 are adjusted. More specifically, the face veneers 10a, each of the back veneers 10b and the center slates 10c of the single panels 100 are divided into a font and back use and a core plate use and woven by mending the single panels 10 with a clipper M7. In a fifth process S5 an adhesive is applied. More specifically, each adhesive are blended as usage of the plywood 1 by a glue mixer M8 and the blended adhesive is applied to both face of the center slate 10c by a spreader M9. In this embodiment an adhesive wherein cedarwood oil 4 is mixed into a resin base 3 is used as the adhesive 2 for wood used in this process, which will be described later. In a sixth process S6 the plywood 1 is cold pressed. More specifically, the face veneer 10a and the back veneer 10b are overlapped with the center slate 10c above and below to which the adhesive 2 for wood is applied and then the face veneer 10a, the center slate 10c and the back veneer 10b each of which is bonded are tentatively compressed at normal temperature by a cold press M10. The plywood 1 to be manufactured comprises an odd number, about 3 through 9, of the single panels 10 piled and bonded as usage and each single panel 10 is arranged in a condition that a fibrous direction of each adjacent single panel 10 makes a right angle alternately. For example, a cross-sectional view of a pattern shown in FIG. 2 shows plywood 1 comprising single panels 10 of five pieces (five plies). Next, in a seventh process S7 hot press is conducted. More specifically, the plywood 1 that has been tentatively pressed in the sixth process S6 is compressed at a temperature of 110 degree Celsius though 135 degree Celsius under a pressure of 8 Kgf/cm²˜12 Kgf/cm² and then the adhesive 2 is hot cured. Next the plywood 1 is cut into a predetermined size by a double saw M12. In a ninth process X9 the plywood 1 is grind finished by a sanding machine M13 so as to make a surface of the plywood 1 flat, and then inspected, thereby to finish the plywood 1 in a state of being able to ship.

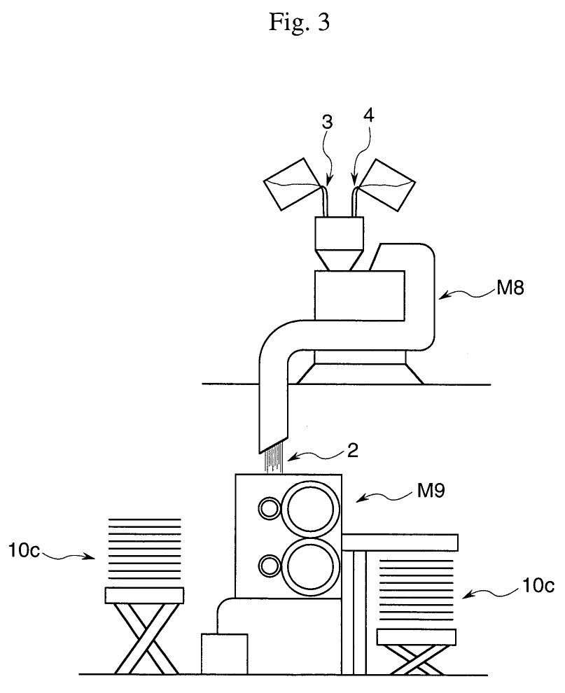

The adhesive 2 for wood that is used for bonding the above-described single panels 10 will be described. First, the adhesive 2 for wood having the easiest arrangement comprises the resin base 3 and the cedarwood oil 4. As the resin base 3 any one of a special group (phenol resin adhesive), 1 group (melamine resin adhesive) <type 1>, 2 group (urea resin adhesive) <type 2> and 3 group (added urea resin adhesive, casein glue) standardized by the JAS may be used, but may be other. The cedarwood oil 4 can be obtained as an extract from plants of Hinoki cypress family such as Aomori cedarwood, Taiwanese cypress, Kiso cypress or the like. In this embodiment used is acid oil out of oil contents extracted from, for example, wood chips, branches or leaves of Aomori cedarwood by means of steam distillation. Thus obtained cedarwood oil 4 contains Tropolone as seven member cyclized chemical compound that is unique to the Hinoki cypress family. The cedarwood oil 4 used in this embodiment is a concentrate solution whose quality is stabilized in a constant condition wherein a content of Hinokitiol (C₁₀H₁₂O₂) and beta-dolabrin (C₁₀H₁₀O₂) as an analogous body of Hinokitiol, which is a component having a highly repelling effect against termite, is about 2%. A diluted solution having an appropriate concentration (for example, 5%) wherein the concentrate solution of the cedarwood oil 4 is diluted with an organic solvent such as ethanol may be used. An appropriate amount (for example, 1·2%) of liquid (either water-based or oil-based) containing Hinokitiol or a metal complex Hinokitiol may be used instead of the above-mentioned cedarwood oil 4. As shown in FIG. 3 wherein the fifth process S5 is shown, the resin base 3 and the cedarwood oil 4 are put into the glue mixer M8, mixed adequately and then applied to the center slate 10c. As shown in FIG. 2, the plywood 1 comprises single panels 10 each of which is overlapped in five layers and the face veneer 10a is arranged at a side locating at the most front, the back veneer 10b is arranged at a side locating at the most back and three pieces of the center slates 10c to which the adhesive 2 for wood is applied are arranged between the face veneer 10a and the back veneer 10b so that a layer 2a of the adhesive 2 for wood is formed between each of the single panel 10. A mixed ratio of the cedarwood oil 4 to the resin base 3 is preferably about 0.1˜3% by weight. In accordance with an arrangement of thus manufactured plywood 1, since the cedarwood oil 4 gradually evaporates from the adhesive 2 for wood, it is possible to obtain an anti-bacterial effect against wood rotting fungi such as Coriolus versicolor and Perenniporia fraxinea or molds and an insect proof effect against termites or Lyctus brunneus. This makes it possible to prevent the plywood 1 form rotting and to provide an insect proof effect such as ant-proof without depending on any chemical agent. In addition, a level of formic aldehyde of the plywood 1 can be lowered simultaneously due to neutralization of formic aldehyde with the cedarwood oil 4.

Further, the adhesive 2 for wood may have an arrangement wherein the cedarwood oil 4 is retained by a porous particle as will be mentioned next.

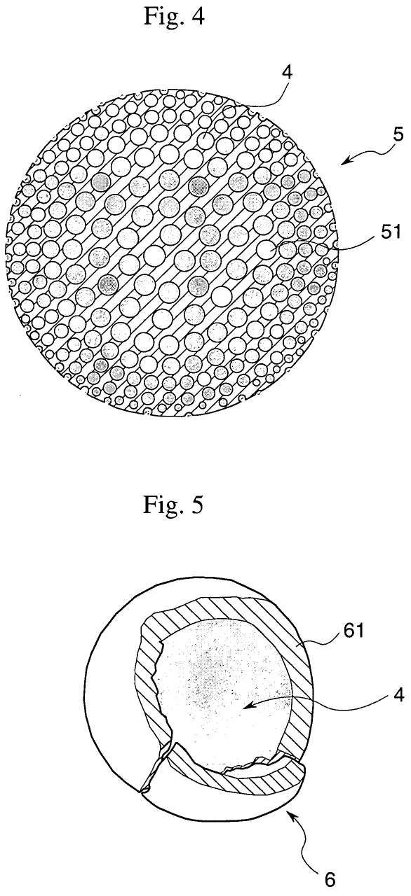

As the porous particle explained is a synthetic silica gel particle 5 as shown in FIG. 4. The synthetic silica gel particle 5 to be used is in a size of several micrometer˜several millimeter having a plurality of fine apertures connecting from a surface of the synthetic silica gel particles 5 to inside thereof. The synthetic silica gel particles 5 are put into a container inside which the cedarwood oil 4 is contained so that the cedarwood oil 4 is adequately absorbed by fine apertures 51 of the synthetic silica gel particles 5. A preferable ratio is 500 gram of the cedarwood oil 4 to 1 kilogram of the synthetic silica gel particles 5. The synthetic silica gel particle 5 absorbing the cedarwood oil 4 are put into the glue mixer M8 together with the resin base 3, fully mixed and then applied to the center slate 10c. A mixed ratio of the synthetic silica gel particle 5 absorbing the cedarwood oil 4 to the resin base 3 is preferably 3% by weight. As mentioned above, in case the cedarwood oil 4 is retained by the fine aperture 51 of the synthetic silica gel particle 5, the cedarwood oil 4 gradually evaporates from the fine aperture 51. As a result of this, the cedarwood oil 4 is gradually released from the adhesive 2 for wood. Then a corrosion proof effect and an insect proof, especially an ant-proof of the plywood 1 will be produced. Further a level of formic aldehyde of the plywood 1 can be lowered simultaneously due to neutralization of formic aldehyde with the cedarwood oil 4. In addition, since the synthetic silica gel particle 5 has a humidity adjusting behavior due to an arrangement of having the fine apertures 51, the plywood 1 using the adhesive 2 for wood wherein the synthetic silica gel particles 5 are mixed would have a humidity adjusting function. In addition to the synthetic silica gel particle 5, diatomite, zeolite or pumicite may be applied as the porous particle. Since an adhesive for wood using diatomite, zeolite or pumicite can be manufactured in the same processes as that of the adhesive 2 for wood using the synthetic silica gel particles 5, an explanation will be omitted.

Further, a microcapsule wherein the cedarwood oil 4 is retained in a space inside a septal wall formed by a plurality of porous particles may be used as a support carrier of the cedarwood oil 4. FIG. 5 is a cross-sectional view of a pattern of the microcapsule 6 wherein a lump of the synthetic silica gel particles 5 is used as a septal wall 61 and shows a condition that a part of the septal wall 61 collapses so as to be stripped. In an inside space surrounded by the septal wall 61 retained is the cedarwood oil 4. Thus arranged microcapsule 6 can be manufactured in a conventional process with a conventional device for manufacturing microcapsules wherein the cedarwood oil 4 and the synthetic silica gel 5 are atomized and sprayed inside the vacuum device. A mixed ratio of the cedarwood oil 4 to the synthetic silica gel particle 5 is preferably about 50% by weight. Like the above-mentioned, the microcapsule 6 is put into the glue mixer M8 together with the resin base 3 in the fifth process S5, fully mixed and then applied to the center slate 10c. A mixed ratio of the microcapsule 6 to the resin base 3 is preferably about 3% by weight. In accordance with the plywood 1 using the adhesive 2 for wood, a part of the septal wall 61 of the microcapsule 6 in the adhesive 2 for wood collapses and stripped so that the cedarwood oil 4 in the microcapsule 6 is released from the microcapsule 6 or the cedarwood oil 4 is released through a gap between the synthetic silica gel particles 5 constituting the septal wall 61 or the fine aperture 51 of the synthetic silica gel particles 5. As a result of this, not only a corrosion proof effect and an ant-proof effect can be obtained but also a level of formic aldehyde of the plywood 1 can be lowered due to a behavior of the cedarwood oil 4. In this case also in addition to the synthetic silica gel particle 5, diatomite, zeolite or pumicite may be applied as the porous particle to be the septal wall 61 of the microcapsule 6.

Further different embodiment of the adhesive 2 for wood represented is that the cedarwood oil 4 is retained by a thickening agent generally blended with the resin base 3. As an example of the thickening agent represented is sepiolite as a mineral thickening agent. The sepiolite is a natural hydrated magnesium silicate mineral containing aluminum component of 4˜5% and has a hollow tunnel portion in a crystal structure. The cedarwood oil 4 is absorbed and retained by the tunnel portion. A mixed ratio of the cedarwood oil 4 to the sepiolite is preferably about 20% by weight. The sepiolite retaining the cedarwood oil 4 may be mixed with the resin base 3 in an ordinal compounding ratio. In accordance with the arrangement, not only a corrosion proof effect and an ant-proof effect can be obtained but also a level of formic aldehyde of the plywood 1 can be lowered due to a behavior of the cedarwood oil 4 emitted from the sepiolite.

The present claimed invention is not limited to the above-described plywood 1 but may be applied to various woody materials such as laminated veneer lumber (LVL) or particleboard manufactured by the use of the adhesive 2 for wood. In this case also the same effect as that of the plywood 1 is produced. Other concrete structure of the adhesive 2 for wood is not limited the above-described embodiment and may be variously modified without departing from the spirit of the invention.

As mentioned above, the present claimed invention is the adhesive for wood whose arrangement is that the cedarwood oil is retained by the rein base. By making use of the adhesive for wood, the woody materials comprises the plywood such as the bonded single panel or the bonded wortle, the laminated veneer lumber or particleboard. Due to the arrangement there is no need of using a conventional chemical agent such as preservative substances nor termite proof agent. The woody material such as plywood can be protected from corrosion and insect commencing from termite just by using the adhesive wherein the cedarwood oil is mixed into the resin base. In addition, due to the eliminant behavior against formic aldehyde of the cedarwood oil, the concentration of formic aldehyde that is a cause of sick house syndrome can be lowered. As a result, the woody material can be made low in the concentration level of formic aldehyde.

1. An adhesive for wood whose main component is a resin base for an adhesive, and characterized by that cedarwood oil is mixed into the resin base.

2. The adhesive for wood described in claim 1, wherein a concentrate solution or a diluted solution of cedarwood oil is mixed into the resin base.

3. The adhesive for wood described in claim 1 or 2, wherein a porous particle having a humidity adjusting behavior is mixed into the resin base and the cedarwood oil is retained by the porous particle.

4. The adhesive for wood described in claim 3, wherein a micro capsule that comprises a hollow septal wall made of a plurality of porous particles and the cedarwood oil included in the septal wall and that can discharge the cedarwood oil out of the septal wall through a fine porosity of the porous particles constituting the septal wall or through a part of a flaked septal wall is mixed into the resin base.

5. The adhesive for wood described in claim 3 or 4, wherein the porous particle is either one of silica gel, diatomite, zeolite and pumicite or a mixture of more than two of silica gel, diatomite, zeolite and pumicite.

6. The adhesive for wood described in claim 1, 2, 3, 4 or 5, wherein the resin base contains a mineral thickening agent and the cedarwood oil is retained by the mineral thickening agent.

7. The adhesive for wood described in claim 6, wherein the mineral thickening agent is sepiolite.

8. The adhesive for wood described in claim 1, 2, 3, 4, 5, 6 or 7, wherein liquid containing Hinokitiol or a metal complex Hinokitiol is mixed into the resin base instead of the cedarwood oil.

9. A woody material wherein a plurality of woody single panels or a plurality of wortles are overlapped in layers and each of adjacent single panels or each of adjacent wortles is bonded with an adhesive for wood applied between the adjacent single panels or the adjacent wortles and characterized by that a main component of the adhesive for wood is a resin base for an adhesive and cedarwood oil is mixed into the resin base.

10. The woody material described in claim 9 and that is plywood wherein an odd number of the single panels are arranged in a condition that a fibrous direction of each adjacent single panel makes a right angle alternately.

11. The woody material described in claim 9 and that is laminated veneer lumber wherein a plurality of the single panels are arranged in a condition that a fibrous direction of each single panel is generally parallel.

12. The woody material described in claim 9 and that is particleboard wherein a plurality of the wortles are arranged in a condition that a fibrous direction of each wortle is generally parallel.

13. The woody material described in claim 9, 10, 11 or 12, wherein the woody material is so arranged that a decorative sheet is bonded with a front face of a single panel or a wortle arranged at the most front side by the use of an adhesive and a main component of the adhesive is a resin base for an adhesive and cedarwood oil is mixed into the resin base.

14. The woody material described in claim 9, 10, 11, 12 or 13, wherein a concentrate solution or a diluted solution of cedarwood oil is mixed into the resin base.

15. The woody material described in claim 9, 10, 11, 12, 13 or 14, wherein a porous particle having a humidity adjusting behavior is mixed into the resin base and the cedarwood oil is retained by the porous particle.

16. The woody material described in claim 15, wherein a micro capsule that comprises a hollow septal wall made of a plurality of porous particles and the cedarwood oil included in the septal wall and that can discharge the cedarwood oil out of the septal wall through a fin porosity of the porous particles constituting the septal wall or a part of a flaked septal wall is mixed into the resin base.

17. The woody material described in claim 15 or 16, wherein the porous particle is either one of silica gel, diatomite, zeolite and pumicite or a mixture of more than two of silica gel, diatomite, zeolite and pumicite.

18. The woody material described in claim 9, 10, 11, 12, 13, 14, 15, 16 or 17, wherein the resin base contains a mineral thickening agent and the cedarwood oil is retained by the mineral thickening agent.

19. The woody material described in claim 18, wherein the mineral thickening agent is sepiolite.

20. The woody material described in claims 9, 10, 11, 12, 13, 14, 15, 16, 17, 18 or 19, wherein liquid containing Hinokitiol or a metal complex Hinokitiol is mixed into the resin base instead of the cedarwood oil.
